(19) United States
(12) Patent Application Publication
(10) Pub. No.: US 2008/0179232 A1
(43) Pub. Date: Jul. 31, 2008

(54) SEWAGE FLOATING/DECONTAMINATING TANK STRUCTURE

(76) Inventor: CHENG-HUA SHEN, Taipei County (TW)

Correspondence Address: CHARLES C.H. WU, 98 DISCOVERY, IRVINE, CA, 92618-3105, US

(21) Appl. No.: 11/958,269

(22) Filed: Dec. 17, 2007

(30) Foreign Application Priority Data
Jan. 26, 2007 (TW) 096201672

(51) Int. Cl. C02F 1/24

(52) U.S. Cl. 210/221.1

(57) ABSTRACT

A sewage floating/decontaminating tank structure including a first tank and a second tank. The first tank has an inlet and a relief outlet. The sewage is conducted from the first inlet into the first tank to flow in a preset flowing path inside the first tank and then discharge from the relief outlet of the first tank. The second tank has an inlet communicating with the relief outlet of the first tank, whereby the sewage is conducted from the relief outlet of the first tank into inlet of the second tank. The sewage is decontaminated in the second tank. The second tank has an exhaustion section arranged on an upper portion of the second tank. The contaminants floating on the level of the sewage in the second tank are exhausted from the exhaustion section. The second tank further an outlet arranged on a lower portion of the second tank. The purified water free from the contaminants is conducted out from the outlet of the second tank for reuse.

### BACKGROUND OF THE INVENTION

The present invention is related to an improved sewage floating/decontaminating tank structure, and more particularly to a sewage floating/decontaminating tank structure having a first tank and a second tank respectively for mixing procedure and precipitation procedure. The sewage floating/decontaminating tank structure is capable of providing better purifying effect to achieve cleaner reusable water.

A conventional sewage floating/decontaminating apparatus is generally equipped with a tank for containing sewage. Bubbles are added into the tank. The bubbles are stained with the dirt in the sewage to buoy up to the level, forming a floating layer of foams. The floating foams are then removed. By means of such sewage disposing apparatus, the water resource can be recovered and reused. Accordingly, the consumption of the water can be reduced and the cost for the water can be lowered. Such sewage disposing apparatus is widely applied to fish cultures, sewerage plants and secondary utility of civil water.

It is known that the conventional sewage floating/decontaminating apparatus is further equipped with a blending unit for expediting the contact between the bubbles and the pollutants. In addition, a material for absorbing the dirt can be added into the sewage. The blending unit serves to expedite the absorption of the dirt. Also, an absorbent can be added into the sewage for absorbing toxic components to obtain cleaner secondary usable water.

It is tried by the applicant to provide a sewage floating/decontaminating apparatus with different structure and better filtering effect. The sewage floating/decontaminating apparatus is applicable to wider range and daily life, especially in those districts lacking water resource.

### SUMMARY OF THE INVENTION

It is therefore a primary object of the present invention to provide an improved sewage floating/decontaminating tank structure having multiple tanks respectively for mixing procedure and precipitation procedure. Therefore, the sewage floating/decontaminating tank structure is capable of providing better purifying effect to achieve cleaner reusable water.

According to the above object, the sewage floating/decontaminating tank structure of the present invention includes a first tank and a second tank. The first tank has a first inlet, a second inlet and a relief outlet. The sewage is conducted into the first tank from the first inlet. A decontaminating agent is added into the first tank from the second inlet. The sewage flows in a preset flowing path inside the first tank and then discharges from the relief outlet of the first tank. The second tank has an inlet communicating with the relief outlet of the first tank via a communicating member. The sewage is conducted from the relief outlet of the first tank into inlet of the second tank through the communicating member. The sewage is secondarily decontaminated in the second tank. The second tank has an exhaustion section arranged on an upper portion of the second tank. The contaminants floating on the level of the sewage in the second tank automatically spill out from the exhaustion section or are exhausted from the exhaustion section by means of a cleaning unit. The second tank further an outlet arranged on a lower portion of the second tank. The purified water free from the contaminants is conducted out from the outlet of the second tank for reuse. The sewage floating/decontaminating tank structure of the present invention further includes a blending unit disposed in at least one of the first tank and the second tank. The blending unit serves to fully mix the decontaminating agent with the sewage so as to achieve better decontaminating effect.

The present invention can be best understood through the following description and accompanying drawings wherein:

### BRIEF DESCRIPTION OF THE DRAWINGS

FIG. 1 is a perspective view of the present invention;

FIG. 2 is a sectional view according to FIG. 1; and

FIG. 3 is a sectional view according to FIG. 2, showing the operation of the present invention.

### DETAILED DESCRIPTION OF THE PREFERRED EMBODIMENTS

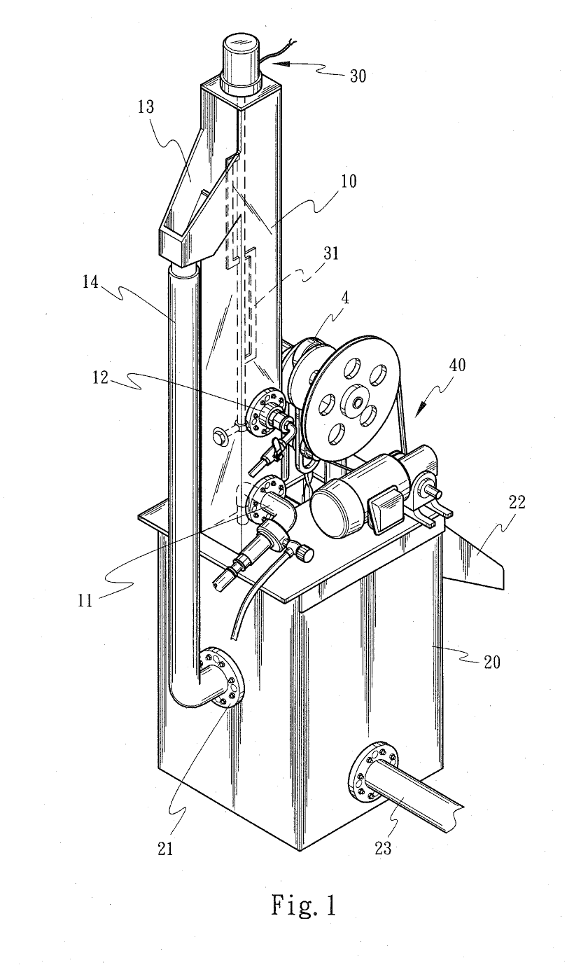

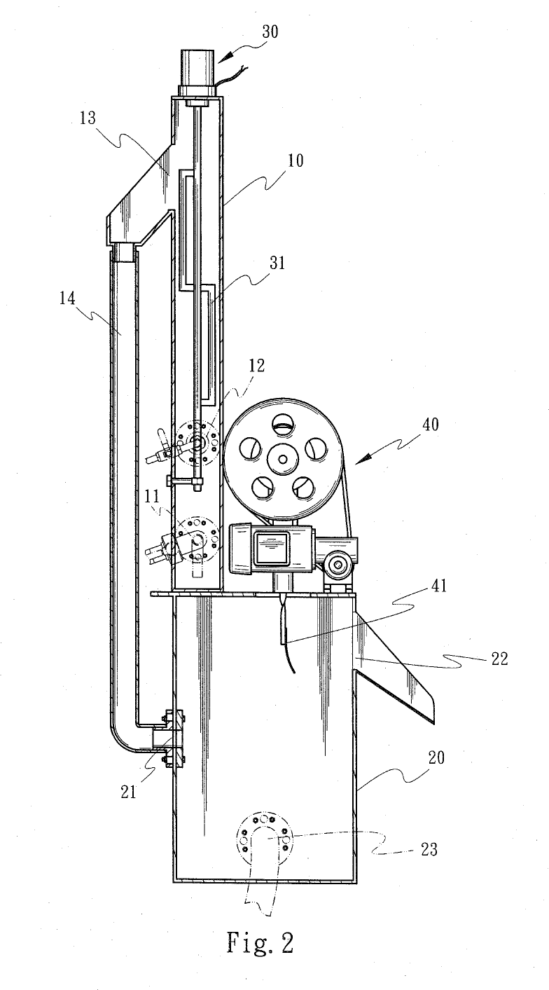

Please refer to FIGS. 1 and 2. The present invention includes a first tank 10 having a first inlet 11 and a second inlet 12 as well as a relief outlet 13 arranged at upper end of the first tank 10. The sewage is conducted into the first tank 10 from the first inlet 11. A decontaminating agent is added into the first tank 10 from the second inlet 12. The sewage flows in a preset Flowing path inside the first tank 10 to discharge from the relief outlet 13. A communicating member 14 communicates the first tank 10 with a second tank 20 positioned under the first tank 10. The sewage is conducted through the communicating member 14 from the first tank 10 to the second tank 20. The second tank 20 has a size larger than that of the first tank 10. The second tank 20 has an inlet 21 communicating with the relief outlet 13 of the first tank 10. The sewage is conducted into the second tank 20 for secondary decontaminating procedure. An exhaustion section 22 is arranged on an upper portion of a sidewall of the second tank 20. The contaminants floating on the level of the sewage in the second tank 20 will automatically spill from the exhaustion section 22. Alternatively, a cleaning unit 40 can be arranged for exhausting the foams floating on the level. In this embodiment, the cleaning unit 40 has a scraping plate 41 for pushing the foams and impurities floating on the level toward the exhaustion section 22. The second tank 20 has an outlet 23 arranged on a lower portion of a sidewall of the second tank 20. The secondary water free from the impurities is conducted out from the outlet 23.

In this embodiment, the first tank 10 is positioned above the second tank 20. The first tank 10 is vertically arranged and has an elongated configuration, whereby the sewage can quickly pass through the first tank 10 with effect. In addition, there is a longer distance for the blending operation. The sewage mixed with gases is conducted from outer side into the first inlet 11 at the lower end of the first tank 10. The decontaminating agent is added into the first tank 10 from the second inlet 12. The decontaminating agent goes up from lower side of the first tank 10. In this embodiment, in order to more evenly spread the bubbles and decontaminating agent over the sewage, a blending unit 30 is mounted in the first tank 10. The blending unit 30 has a blender 31 vertically disposed in the first tank 10. When the sewage flows through the narrow and elongated space of the first tank 10, the blending unit 30 serves to fully evenly mix the bubbles and the decontaminating agent with the sewage. Then the sewage is exhausted from the relief outlet 13 disposed on upper side of the first tank 10.

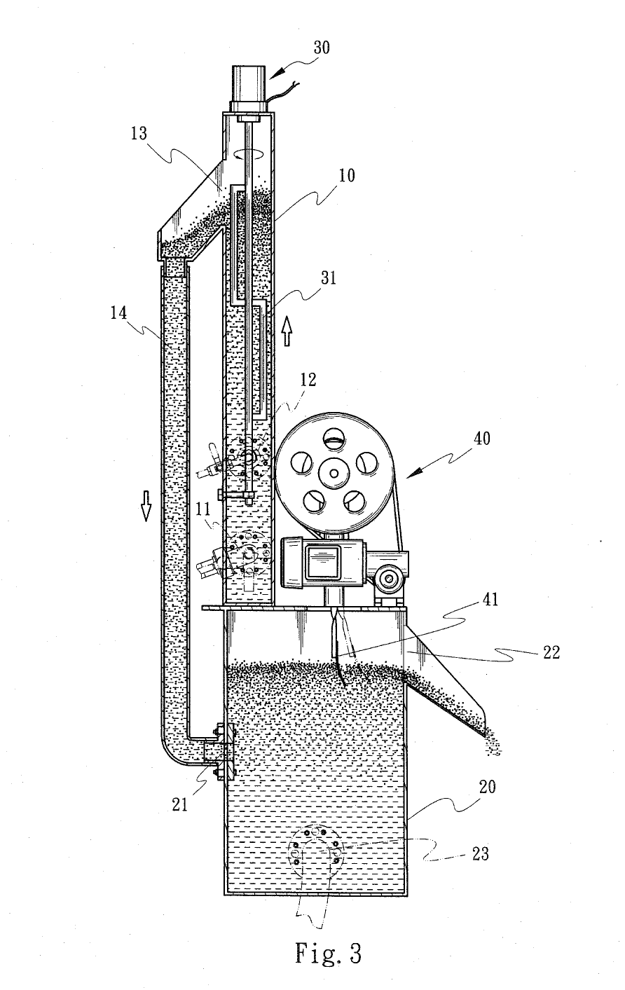

FIG. 3 shows the purification and filtration of the sewage according to the present invention. The sewage entraining gases is pumped into the bottom of the first tank 10 by means of an external pump. At this time, the level of the sewage in the first tank 10 will rise. The blender 31 simultaneously stirs the sewage to evenly mix the sewage with the bubbles and the decontaminating agent. In the narrow and elongated flowing path, there is enough time for the bubbles and the decontaminating agent to absorb the dirt contained in the sewage. When the level continuously rises to a position near the top end of the first tank 10, the sewage will flow out from the relief outlet 13 into the communicating member 14 which is a conduit in this embodiment. The sewage fully mixed with bubbles goes from the inlet 21 into the wider second tank 20. In this embodiment, the inlet 21 is arranged on the second tank 20 near a middle section thereof. The foams fully stained with the contaminants gradually buoy up toward the level of the sewage in the second tank 20 and accumulate on the level. The purified water sinks toward the lower side of the second tank 20. The contaminants entrained by the foams gradually spill out from the exhaustion section 22. Alternatively, the contaminants are scraped out by the scraping plate 41. The sinking purified water is conducted out of the second tank 20 from the outlet 23 at the lower end of the second tank 20 for reuse.

It should be noted that the sewage and the decontaminating agent are fully mixed in the first tank 10. Then the mixture is conducted into the second tank 20 and reserved therein. Through precipitation, the purified water and the contaminants are separated. In practice, the mixing procedure is performed before the separation of the contaminants and the water. Therefore, during the reservation and precipitation, the contaminants can be more fully separated from the water. In contrast, in the conventional sewage floating/decontaminating apparatus, the mixing operation, the precipitation and the removal of the contaminants are performed at the same time in one single tank. When stirring the sewage to mix the decontaminating agent with the contaminants, the contaminants can hardly fully separate from the water. In comparison with the conventional sewage floating/disposing apparatus, the sewage floating/decontaminating tank of the present invention has better decontaminating effect.

In conclusion, the sewage floating/decontaminating tank of the present invention has two separate tanks. The mixing procedure is performed in the first tank and the reservation and precipitation procedure is performed in the second tank after the mixing procedure so that the contaminants can be more fully separated from the water.

The above embodiments are only used to illustrate the present invention, not intended to limit the scope thereof. Many modifications of the above embodiments can be made without departing from the spirit of the present invention.

What is claimed is:

1. A sewage floating/decontaminating tank structure comprising a first tank and a second tank, the first tank having a first inlet and a relief outlet, the sewage being conducted from the first inlet into the first tank to flow in a preset flowing path inside the first tank, the sewage being then discharged from the relief outlet of the first tank into the second tank, the sewage being decontaminated in the second tank, the second tank having an exhaustion section arranged on an upper portion of the second tank, whereby the contaminants floating on the level of the sewage in the second tank are exhausted from the exhaustion section, the second tank having an outlet arranged on a lower portion of the second tank, whereby the purified water free from the contaminants is conducted out from the outlet for reuse.

2. The sewage floating/decontaminating tank structure as claimed in claim 1, further comprising a blending unit, the blending unit having a blender disposed in at least one of the first tank and the second tank.

3. The sewage floating/decontaminating tank structure as claimed in claim 2, wherein the blender is disposed in the first tank.

4. The sewage floating/decontaminating tank structure as claimed in claim 1, wherein the first tank has a narrow and elongated configuration relative to the second tank.

5. The sewage floating/decontaminating tank structure as claimed in claim 2, wherein the first tank has a narrow and elongated configuration relative to the second tank.

6. The sewage floating/decontaminating tank structure as claimed in claim 1, wherein the first inlet is arranged on a portion of the first tank near a lower end thereof.

7. The sewage floating/decontaminating tank structure as claimed in claim 2, wherein the first inlet is arranged on a portion of the first tank near a lower end thereof.

8. The sewage floating/decontaminating tank structure as claimed in claim 1, wherein the first tank has a second inlet.

9. The sewage floating/decontaminating tank structure as claimed in claim 2, wherein the first tank has a second inlet.

10. The sewage floating/decontaminating tank structure as claimed in claim 6, wherein the first tank has a second inlet.

11. The sewage floating/decontaminating tank structure as claimed in claim 8, wherein the second inlet is arranged on a portion of the first tank near a lower end thereof.

12. The sewage floating/decontaminating tank structure as claimed in claim 9, wherein the second inlet is arranged on a portion of the first tank near a lower end thereof.

13. The sewage floating/decontaminating tank structure as claimed in claim 1, wherein the second tank is positioned under the first tank and has an inlet, the relief outlet of the first tank communicating with the inlet of the second tank via a communicating member.

14. The sewage floating/decontaminating tank structure as claimed in claim 2, wherein the second tank is positioned under the first tank and has an inlet, the relief outlet of the first tank communicating with the inlet of the second tank via a communicating member.

15. The sewage floating/decontaminating tank structure as claimed in claim 6, wherein the second tank is positioned under the first tank and has an inlet, the relief outlet of the first tank communicating with the inlet of the second tank via a communicating member.

16. The sewage floating/decontaminating tank structure as claimed in claim 8, wherein the second tank is positioned under the first tank and has an inlet, the relief outlet of the first tank communicating with the inlet of the second tank via a communicating member.

17. The sewage floating/decontaminating tank structure as claimed in claim 1, wherein the inlet of the second tank is arranged on a middle portion of the second tank.

18. The sewage floating/decontaminating tank structure as claimed in claim 2, wherein the inlet of the second tank is arranged on a middle portion of the second tank.

19. The sewage floating/decontaminating tank structure as claimed in claim 6, wherein the inlet of the second tank is arranged on a middle portion of the second tank.

20. The sewage floating/decontaminating tank structure as claimed in claim 8, wherein the inlet of the second tank is arranged on a middle portion of the second tank.

21. The sewage Floating/decontaminating tank structure as claimed in claim 13, wherein the inlet of the second tank is arranged on a middle portion of the second tank.

22. The sewage floating/decontaminating tank structure as claimed in claim 1, wherein a cleaning unit is arranged on the second tank near the exhaustion section thereof for exhausting the contaminants out of the second tank, the cleaning unit having at least one scraping plate.

23. The sewage floating/decontaminating tank structure as claimed in claim 2, wherein a cleaning unit is arranged on the second tank near the exhaustion section thereof for exhausting the contaminants out of the second tank, the cleaning unit having at least one scraping plate.

24. The sewage floating/decontaminating tank structure as claimed in claim 6, wherein a cleaning unit is arranged on the second tank near the exhaustion section thereof for exhausting the contaminants out of the second tank, the cleaning unit having at least one scraping plate.

25. The sewage floating/decontaminating tank structure as claimed in claim 8, wherein a cleaning unit is arranged on the second tank near the exhaustion section thereof for exhausting the contaminants out of the second tank, the cleaning unit having at least one scraping plate.

26. The sewage floating/decontaminating tank structure as claimed in claim 13, wherein a cleaning unit is arranged on the second tank near the exhaustion section thereof for exhausting the contaminants out of the second tank, the cleaning unit having at least one scraping plate.

27. The sewage floating/decontaminating tank structure as claimed in claim 17, wherein a cleaning unit is arranged on the second tank near the exhaustion section thereof for exhausting the contaminants out of the second tank, the cleaning unit having at least one scraping plate.
